(19) United States
(12) Patent Application Publication
(10) Pub. No.: US 2024/0426012 A1
(43) Pub. Date: Dec. 26, 2024

(54) ELECTROLYZER WITH IMPACTOR

(71) Applicant: Davy Gas Inc., Cincinnati, OH (US)

(72) Inventors: James M. Oros, Asheville, NC (US); Patrick J. Pelch, Meridian, ID (US)

(21) Appl. No.: 18/750,886

(22) Filed: Jun. 21, 2024

Related U.S. Application Data
(60) Provisional application No. 63/522,992, filed on Jun. 23, 2023.

(51) Int. Cl. C25B 15/08; C25B 9/19

(52) U.S. Cl. CPC C25B 15/085; C25B 9/19

(57) ABSTRACT

Disclosed herein are components of an electrolyzer and methods of operation thereof to improve electrolysis operations. The electrolyzer includes an impactor that repeatedly impacts a first electrode, a second electrode, a diaphragm, or a housing of the electrolyzer with a force sufficient to dislodge at least some of the gas bubbles that are attached to the electrodes. The gas bubbles being a result of a chemical reaction of a liquid electrolyte within the electrolyzer.

### CROSS-REFERENCE TO RELATED APPLICATION

This application claims the benefit of Provisional Application No. 63/522,992, filed Jun. 23, 2023, the disclosure of which is hereby incorporated by reference in its entirety herein.

### BACKGROUND

### Technical Field

This disclosure relates generally to electrolyzers that produce hydrogen gas from water, and more specifically relates to electrolyzers that reduce bubble buildup and promote bubble propagation.

### Description of the Related Art

An electrolyzer is a device capable of splitting water molecules into their constituent oxygen and hydrogen atoms. Known electrolyzers include a conductive electrode stack separated by a membrane. A high voltage electric current generates an electric current in the water, breaking the water down into its components of hydrogen and oxygen. The oxygen generated may be released into the atmosphere or stored for use (e.g., as a medical or industrial gas). The hydrogen may be stored as a compressed gas or liquefied for use (e.g., in hydrogen fuel cells to power transport vehicles).

Known electrolyzers may be part of a larger system including pumps, power generation/delivery, a gas separator, storage tanks, etc. There are different types of known electrolyzers including: alkaline; proton exchange membrane (PEM); and solid oxide electrolysis cell (SOEC).

Known alkaline electrolyzers include a liquid electrolyte solution (e.g., potassium/sodium hydroxide and water). Hydrogen is produced in a cell that includes an anode, a cathode, and a membrane. Multiple cells may be positioned in series to form a “stack” thereby increasing hydrogen and oxygen production. When current is applied to the cell/stack, hydroxide ions move through the liquid electrolyte solution from the cathode to the anode of each cell, generating bubbles of hydrogen gas on the cathode side of the electrolyzer and oxygen gas on the anode side.

Known PEM electrolyzers include a proton exchange membrane and a solid polymer electrolyte. The application of electric current splits water into hydrogen and oxygen. The hydrogen protons pass through the membrane to form hydrogen gas on the cathode side.

Known SOECs operate at a higher temperature (e.g., between 50° and 850° C.) than other known electrolyzers. Also referred to as high-temperature electrolysis (HTE) or steam electrolysis, a solid ceramic material serves as the electrolyte. Electrons from an external circuit combine with water at a cathode to form hydrogen gas and negatively charged ions. Oxygen then passes through the sliding ceramic membrane and reacts at an anode to form oxygen gas and generate electrons for the external circuit.

Other types of electrolyzers known, but are typically not yet as efficient or cost-effective as those referenced above. For example, photoelectrolysis uses only sunlight to separate water molecules without the need for electricity.

### BRIEF SUMMARY

The present disclosure provides an improved electrolyzer that reduces bubble buildup and improves bubble propagation.

According to one embodiment, an electrolyzer includes a first electrode at least partially submerged in a liquid electrolyte, and a second electrode at least partially submerged in the liquid electrolyte. A difference in the electric charge of the first electrode and the second electrode is sufficient to cause a chemical reaction within the liquid electrolyte that results in the production of gas bubbles.

The electrolyzer further includes a diaphragm positioned between the first electrode and the second electrode, and a housing that at least partially encloses the first electrode, the second electrode, the diaphragm, the liquid electrolyte, or any combination thereof. The electrolyzer further includes an impactor that repeatedly impacts the first electrode, the second electrode, the diaphragm, or the housing with a force sufficient to dislodge at least some of the gas bubbles that are attached to the first electrode and/or dislodge at least some of the gas bubbles that are attached to the second electrode.

Additional embodiments described herein provide a method of electrolysis. The method includes at least partially submerging a first electrode and a second electrode in a liquid electrolyte, inducing a flow of electrons from the first electrode to the second electrode, and inducing a chemical reaction in the liquid electrolyte, the chemical reaction generating bubbles of a first gas formed closer to the first electrode and further generating bubbles of a second gas formed closer to the second electrode.

The method further includes impacting the first electrode, the second electrode, or both with a force sufficient to dislodge at least some of the bubbles of the first gas that are attached to the first electrode and/or dislodge at least some of the bubbles of the second gas that are attached to the second electrode.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic view of a known electrolyzer, according to one embodiment.

FIG. 2 is a schematic view of an electrolyzer including an impactor, according to one embodiment.

FIG. 3 is an enlarged view of portion A of FIG. 2, showing the impactor according to one embodiment in a first position.

FIG. 4 is a schematic view of the impactor illustrated in FIG. 3, showing the impactor in a second position.

FIG. 5 is an enlarged view of portion A of FIG. 2, showing the impactor according to one embodiment in a first position.

FIG. 6 is a schematic view of the impactor illustrated in FIG. 5, showing the impactor in a second position.

FIG. 7 is a front, top, exploded, isometric view of the electrolyzer illustrated in FIG. 2, according to one embodiment.

FIG. 8 is a rear, top, exploded, isometric view of the electrolyzer illustrated in FIG. 7.

FIG. 9 is front elevation view of the electrolyzer illustrated in FIG. 7, with a portion of the housing removed and the impactor in an extended configuration.

FIG. 10 is front elevation view of the electrolyzer illustrated in FIG. 9, with the impactor in a retracted configuration.

### DETAILED DESCRIPTION

In the following description, certain specific details are set forth to provide a thorough understanding of various disclosed embodiments. However, one of ordinary skill in the relevant art will recognize that embodiments may be practiced without one or more of these specific details, or with other methods, components, materials, etc. In other instances, well-known structures associated with electrolyzers have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. For example, certain features of the disclosure which are described herein in the context of separate embodiments may also be provided in combination in a single embodiment. Conversely, various features of the disclosure that are described in the context of a single embodiment may also be provided separately or in any subcombination.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise. Reference herein to two elements “facing” or “facing toward” each other indicates that a straight line can be drawn from one of the elements to the other of the elements without contacting an intervening solid structure.

The term “aligned” as used herein in reference to two elements along a direction means a straight line that passes through one of the elements and that is parallel to the direction will also pass through the other of the two elements. The term “between” as used herein in reference to a first element being between a second element and a third element with respect to a direction means that the first element is closer to the second element as measured along the direction than the third element is to the second element as measured along the direction. The term “between” includes, but does not require that the first, second, and third elements be aligned along the direction.

Recitation of ranges of values herein are merely intended to serve as a shorthand method of referring individually to each separate value falling within the range including the stated ends of the range, unless otherwise indicated herein, and each separate value is incorporated into the specification as if it were individually recited herein.

Aspects of the disclosure will now be described in detail with reference to the drawings, wherein like reference numbers refer to like elements throughout, unless specified otherwise. Certain terminology is used in the following description for convenience only and is not limiting. The term “plurality,” as used herein, means more than one. The term “at least a portion” of a structure includes the entirety of the structure.

The headings and Abstract of the Disclosure provided herein are for convenience only and do not interpret the scope or meaning of the embodiments.

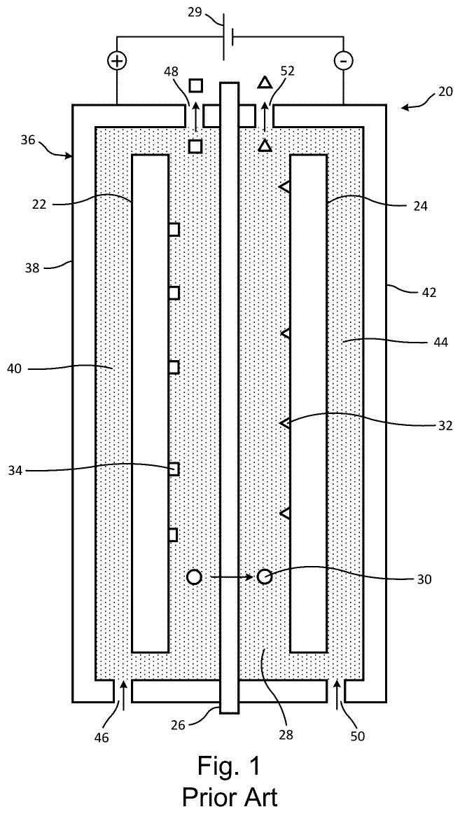

Referring to FIG. 1 a known electrolyzer 20 includes a first electrode 22 and a second electrode 24 separated by a diaphragm 26. The first electrode 22 and the second electrode 24 operate within a liquid electrolyte 28 (e.g., water, or an alkaline electrolyte solution such as potassium hydroxide or sodium hydroxide). The first electrode 22 and the second electrode 24 are electrically connected to a power supply 29 thereby positively charging the first electrode 22 (forming an anode) and negatively charging the second electrode 24 (forming a cathode). The first electrode 22 and the second electrode 24 are typically made of an electrical conducting material (e.g., nickel based metals).

The diaphragm 26 is typically a protonic membrane, thereby preventing passage of electrons from the second electrode 24 to the first electrode 22 through the liquid electrolyte 28. The diaphragm 26 is typically porous with respect to charged ions 30 (e.g., hydroxide ions) within the liquid electrolyte 28 permitting passage of the charged ions through the diaphragm 26 (e.g., away from the second electrode 24 and toward the first electrode 22, or vice versa). The diaphragm 26 for the known electrolyzer 20 may be made of a proton exchange membrane.

Movement of the charged ions 30 from the second electrode 24, through the diaphragm 26, toward the first electrode 22, causes a chemical reaction within the liquid electrolyte 28. The specifics of the chemical reaction may vary based on the specific materials selected for one or more of the components of the known electrolyzer 20. For example, the chemical reaction may generate bubbles of hydrogen gas 32 and bubbles of oxygen gas 34.

The bubbles of oxygen gas 34 typically form on one of the electrodes (e.g., the first electrode 22) and the bubbles of hydrogen gas 32 typically form on the other of the electrodes (e.g., the second electrode 24). The bubbles of oxygen gas 34 and hydrogen gas 32 typically grow in size until offsetting gravity forces overcome the adhering force that attaches the respective bubble to the respective electrode. Once the bubbles reach sufficient size, they detach from their respective electrode, exit the liquid electrolyte 28, and are collected (e.g., outside the known electrolyzer 20).

The known electrolyzer 20 may include a housing 36 that encloses one or more components of the electrolyzer 20. As shown, the housing 36 includes a first portion 38 that forms a first inner volume 40 in cooperation with the diaphragm 26. The housing 36 further includes a second portion 42 that forms a second inner volume 44 in cooperation with the diaphragm 26.

The known electrolyzer 20 includes a first entry passage 46, through which the liquid electrolyte 28 enters the first inner volume 40, and a first exit passage 48 through which a result of the chemical reaction (e.g., the bubbles of oxygen gas 34) exit the first inner volume 40. As shown, the first entry passage 46 and the first exit passage 48 are formed in the first portion 38. The known electrolyzer 20 includes a second entry passage 50, through which the liquid electrolyte 28 enters the second inner volume 44, and a second exit passage 52 through which a result of the chemical reaction (e.g., the bubbles of hydrogen gas 32) exit the second inner volume 44. As shown, the second entry passage 50 and the second exit passage 52 are formed in the second portion 42.

Electrolysis activity/efficiency is a function of surface area of the charged anode/cathode in the presence of the liquid electrolyte 28. Adherence of the bubbles of hydrogen gas 32 and oxygen gas 34 to surfaces of the first electrode 22 and the second electrode 24 diminishes throughput of the chemical reaction (e.g., the amount of bubbles/gas produced). Thus, an electrolyzer that is improved to promote release/liberation of gas bubbles that are in contact with the electrodes of the electrolyzer may result in an electrolyzer with improved efficiency.

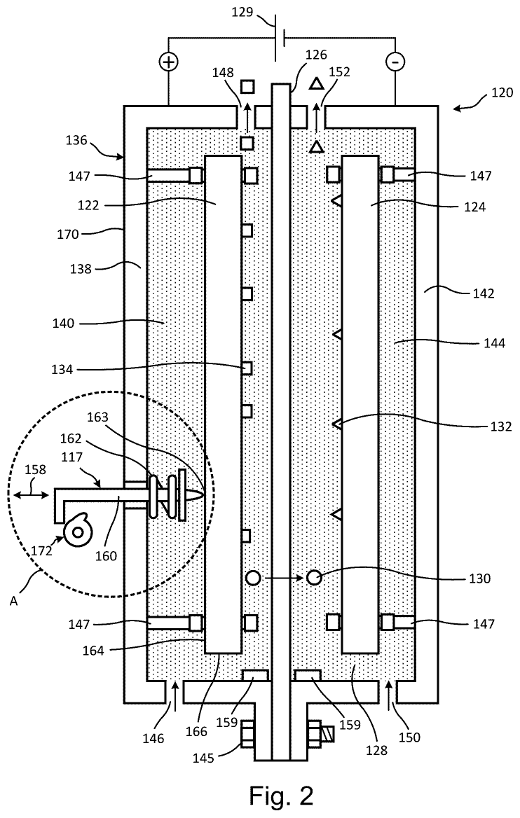

Referring to FIGS. 2 to 6, an electrolyzer 120 may include a first electrode 122 and a second electrode 124 separated by a diaphragm 126. At least one of the first electrode 122 and the second electrode 124 may operate within (i.e., may be at least partially submerged within) a liquid electrolyte 128 (e.g., water, or an alkaline electrolyte solution such as potassium hydroxide or sodium hydroxide). According to one embodiment, the first electrode 122 and the second electrode 124 may both be at least partially submerged within the same liquid electrolyte 128. According to one embodiment, the first electrode 122 may be at least partially submerged within the liquid electrolyte 128, and the second electrode may be at least partially submerged within another liquid (e.g., water). According to one embodiment, the first electrode 122 may be at least partially submerged within the liquid electrolyte 128, and the second electrode may be devoid of direct contact with any liquid.

The first electrode 122 and the second electrode 124 may be electrically connected to a power supply 129 that positively charges the first electrode 122, thereby forming an anode, and negatively charges the second electrode 124, thereby forming a cathode. The power supply 129 may be part of the electrolyzer 120 (e.g., a battery secured relative to the electrolyzer 120, or the power supply 129 may be external (i.e., separate from) the electrolyzer 120.

The first electrode 122 and the second electrode 124 are typically made of an electrical conducting material (e.g., nickel based metals). According to one embodiment, one or both of the first electrode 122 and the second electrode 124 may be a mesh so as to increase the amount of surface area of the first electrode 122 and the second electrode 124 that is in contact with the liquid electrolyte 128. According to one embodiment, the first electrode 122, the second electrode 124, or both may made of a material so as to be conductive and non-consumable during electrolysis.

The diaphragm 126 may be non-conductive to electrons, thereby preventing passage of electrons from the second electrode 124 to the first electrode 122 through the liquid electrolyte 128. The diaphragm 126 may be porous with respect to the liquid electrolyte 128, to charged ions 130 (e.g., hydroxide ions) within the liquid electrolyte 128, or both, permitting passage of the liquid electrolyte 128 and/or the charged ions 130 through the diaphragm 126 (e.g., away from the second electrode 124 and toward the first electrode 122, or vice versa). According to one embodiment, the diaphragm 126 for the electrolyzer 120 may be made of a proton exchange membrane.

Movement of the charged ions 130 from the second electrode 124, through the diaphragm 126, toward the first electrode 122, facilitates a chemical reaction within the liquid electrolyte 128. The specifics of the chemical reaction may vary based on the specific materials selected for one or more of the components of the electrolyzer 120. For example, the chemical reaction may generate bubbles of hydrogen gas 132 and bubbles of oxygen gas 134. As shown in the illustrated embodiment, the bubbles of oxygen gas 134 may form on one of the electrodes (e.g., the first electrode 122, or the anode) and the bubbles of hydrogen gas 132 may form on the other of the electrodes (e.g., the second electrode 124, or the cathode). The diaphragm 126 may be electrolytic, such that the products formed during the chemical reaction are kept separate and are unable to pass through the diaphragm 126.

The electrolyzer 120 may include a housing 136 that encloses one or more components of the electrolyzer 120. As shown, the housing 136 may include a first portion 138 that encloses a first inner volume 140 in cooperation with the diaphragm 126. The housing 136 may further include a second portion 142 that encloses a second inner volume 144 in cooperation with the diaphragm 126. According to one embodiment, the first portion 138 and the second portion 142 may be secured by one or more fasteners 145 (e.g., bolts) inserted through corresponding fastener receiving holes (not shown) in the first portion 138 and the second portion 142. The diaphragm 126 may also include corresponding fastener receiving holes through which the one or more fasteners 145 are inserted to secure the diaphragm 126 relative to the housing 136.

The electrolyzer 120 (e.g., the housing 136) may include one or more supports 147 that secure the first electrode 122 relative to the first portion 138 and that secure the second electrode 124 relative to the second portion 142.

Alternatively, the housing 136 and the first electrode 122 and the second electrode 124 may have corresponding shapes that secure the first electrode 122 and the second electrode 124 relative to the housing 136.

The electrolyzer 120 may include an entry passage 146, through which the liquid electrolyte 128 enters the first inner volume 140, and a first exit passage 148 through which a result of the chemical reaction (e.g., the bubbles of oxygen gas 134) exits the first inner volume 140. As shown, the entry passage 146 and the first exit passage 148 may both be formed in the first portion 138. Alternatively, the first exit passage 148 may be formed in the first portion 138 and the entry passage 146 may be formed in the second portion 142.

According to one embodiment, the liquid electrolyte 128 may be able to flow into both the first inner volume 140 and the second inner volume 144 from the entry passage 146 (e.g., through the diaphragm 126 or an opening of the diaphragm 126). According to another embodiment, the entry passage 146 may be a first entry passage and the electrolyzer 120 may include a second entry passage 150, through which the liquid electrolyte 128 enters the second inner volume 144.

The electrolyzer 120 may include a second exit passage 152 through which a result of the chemical reaction (e.g., the bubbles of hydrogen gas 132) exit the second inner volume 144. As shown, the second entry passage 150 and the second exit passage 152 may be formed in the second portion 142.

The electrolyzer 120 may include an impactor 117 that impacts one or more components of the electrolyzer 120 at an impact location 163. The impacts may occur at regular or irregular intervals, as described in further detail below. For example, the impacts may occur after a selected amount of time passes (e.g., with a frequency of between 0.1 to 5 Hz). According to one embodiment, the impacts may occur based on conditions within the electrolyzer 120 (e.g., the number/amount of bubbles adhered/attached to on one or both of the first electrode 122 and the second electrode 124). As shown, the electrolyzer 120 may include one or more sensors 159 that send a signal to the impactor 117 upon a threshold value being reached of number/amount of bubbles adhered/attached to one or both of the first electrode 122 and the second electrode 124.

The impactor 117 may include a strike pin 160 that moves (e.g., translates in the directions indicated by arrow 158) with respect to a component of the electrolyzer 120 that it impacts. The impactor 117 may further include a biasing member 162 (e.g., a spring) that exerts a force on the strike pin 160 that results in movement of the strike pin 160 towards the component of the electrolyzer 120 and impact with the component.

As shown in FIGS. 2 to 4, the impactor 117 may impact an internal component of the electrolyzer 120 (i.e., a component that is enclosed within the housing 136 and/or submerged within the liquid electrolyte 128, such as the first electrode 122, the second electrode 124, and the diaphragm 126). The strike pin 160 may be positioned to impact a major surface 164 of the first electrode 122, or may be positioned to impact a minor surface 166 (e.g., an outer perimeter) of the first electrode 122. The electrolyzer 120 may include a seal 168 that allows passage of the strike pin 160 through the housing 136 while preventing escape of the liquid electrolyte 128.

As shown in FIGS. 5 and 6, the impactor 117 may impact an external component of the electrolyzer 120 (i.e., a component that is not enclosed within the housing 136 and/or is not submerged within the liquid electrolyte 128, such as an outer surface 170 of the first portion 138 and the second portion 142). The impactor 117 may include a support 171 that positions the strike pin 160 relative to the housing 136. The biasing member 162 may push against the housing 136 to generate a force on the strike pin 160 resulting in movement of the strike pin 160 to impact the housing 136.

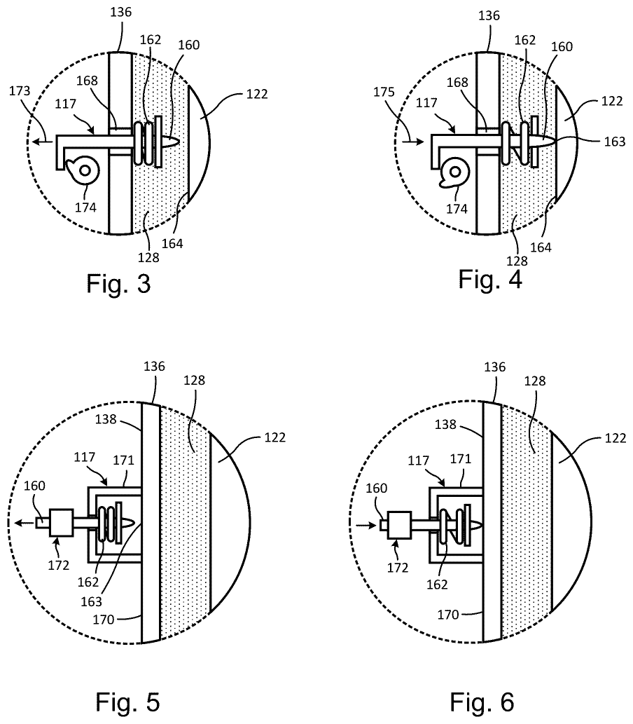

The impactor 117 may include an actuator 172 that moves the strike pin 160 (e.g., along one or more directions indicated by the arrow 158). As shown in FIGS. 2 to 4, the actuator 172 may include a cam 174 that is in sliding contact with the strike pin 160 and that is rotatable relative to the strike pin 160. Rotation of the cam 174 may move (e.g., translate in the direction indicated by arrow 173) the strike pin 160 away from the first electrode 122 (or other component that the impactor 117 impacts) and compress the biasing member 162 (e.g., as shown in FIG. 3).

Further rotation of the cam 174 may release the strike pin 160 such that the biasing member 162, in its compressed configuration, exerts a force on the strike pin 160 moving (e.g., translating in the direction indicated by arrow 175) the strike pin 160 towards the first electrode 122 (or other component that the impactor 117 impacts), as shown in FIG. 4. The impact of the impactor is sufficient to dislodge/liberate some of the bubbles of hydrogen gas 132 and oxygen gas 134 (or other product of the chemical reaction) from the respective first electrode 122 and/or the second electrode 124. According to one embodiment, the force generated by the impactor 117 on the first electrode 122 is about 0.5 to 20 pound force (lbf).

The actuator 172 may be pneumatic, hydraulic, electric, mechanical, magnetic, etc. and as shown in FIGS. 5 and 6, move the strike pin 160 without rotating relative to the strike pin 160. According to one embodiment, the actuator 172 may be capable of moving the strike pin 160 reciprocally such that the biasing member 162 is not needed to generate a force on the strike pin 160. Thus, the impactor 117 may be devoid of the biasing member 162.

The electrolyzer 120 may include one or more than one of the impactors 117 (e.g., to impact one or more components of the electrolyzer 120 either simultaneously or in series).

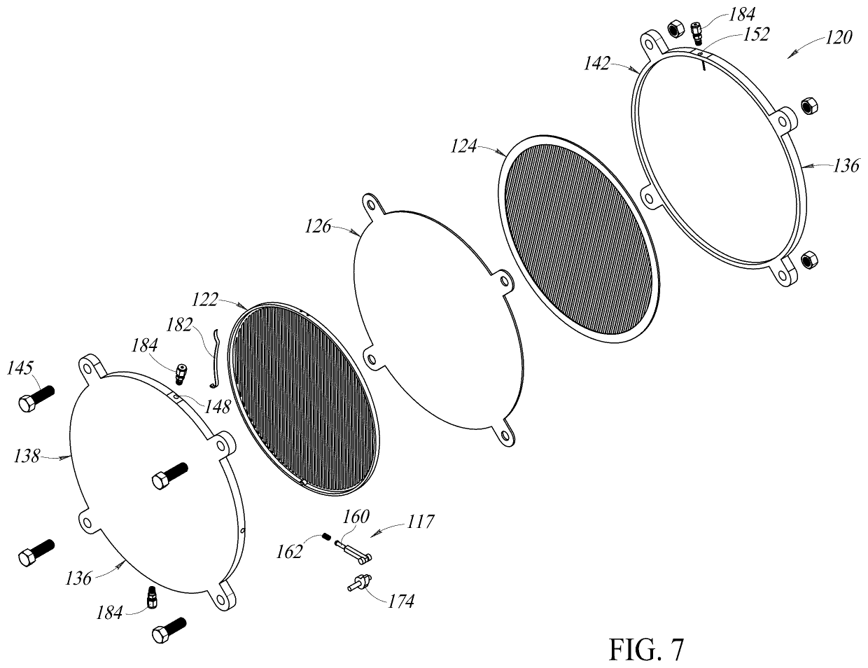

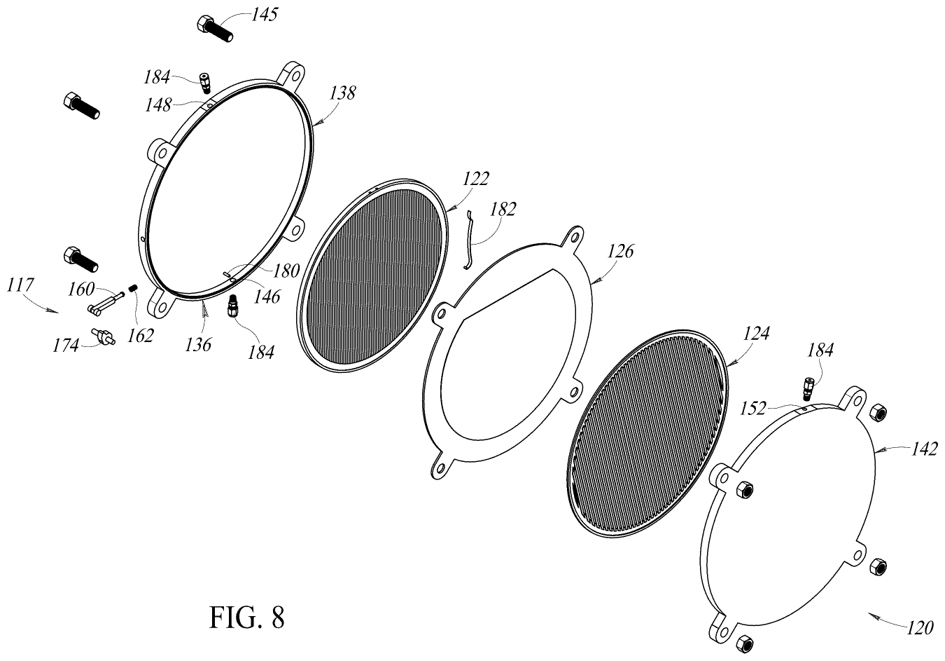

Referring to FIGS. 7 to 10, the electrolyzer 120 may include the first electrode 122, the second electrode 124, and the diaphragm 126 positioned between the first electrode 122 and the second electrode 124 as described in detail above. The first electrode 122 and the second electrode 124 may be enclosed within the housing 136, and the diaphragm 126 may be at least partially enclosed within the housing 136.

The electrolyzer 120 may include an assembled configuration in which the first portion 138 is secured to the second portion 142, the first electrode 122 is captured within the first inner volume 140 between the first portion 138 and the diaphragm 126, and the second electrode 124 is captured within the second inner volume 144 between the second portion 142 and the diaphragm 126.

In the assembled configuration the first electrode 122 may abut or be in close contact (e.g., between about 0.25 in. to about 0.5 in.) with the first portion 138, the diaphragm 126, or both. In the assembled configuration the second electrode 124 may abut or be in close contact (e.g., between about 0.25 in. to about 0.5 in.) with the second portion 142, the diaphragm 126, or both. In the assembled configuration the first electrode 122 may be within about 0.5 in. to about 1.0 in. of the second electrode 124. The values provided above are exemplary, and may be increased or decreased based on the size of the electrolyzer and specific chemical reaction being produced.

According to one embodiment, the support 147 may include a pin 180 that secures the first electrode 122 within the first inner volume 140 relative to the first portion 138, the diaphragm 126, or both. The pin 180 may restrict relative translation of the first electrode 122 within the first inner volume 140 while enabling limited pivoting (e.g., about an axis that extends through the pin 180). When the impactor 117 impacts against the first electrode 122, the electrode may move (e.g., pivot about a pivot point defined by the pin 180). According to another embodiment, the support 147 may secure the first electrode 122 such that all movement (translation and rotation/pivoting) is restricted and/or prevented.

The support 147 may further include a spring clip 182 that positions the first electrode 122 within the first inner volume 140. Upon movement of the first electrode 122 (e.g., pivoting about the pin 180 in response to impact from the impactor 117), the spring clip 182 may exert a force against the first electrode 122 returning the first electrode 122 back to its original position (prior to being impacted by the impactor 117).

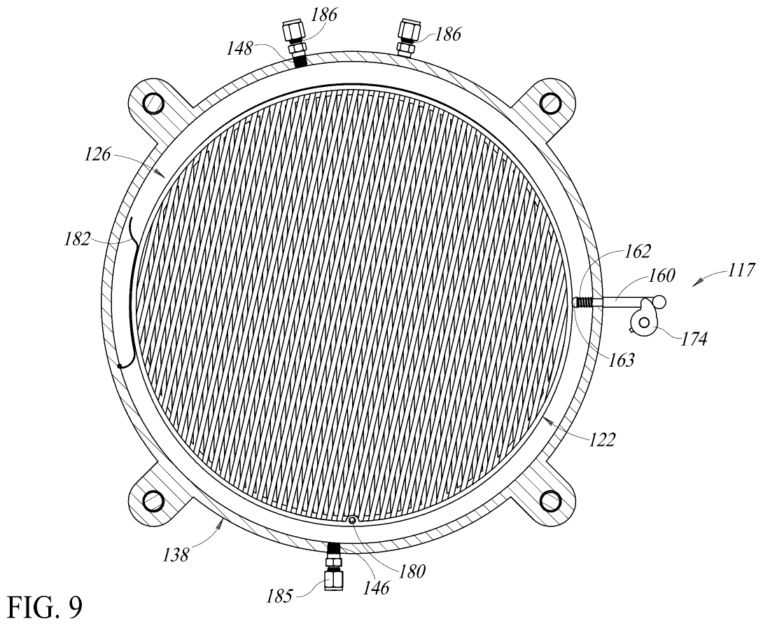

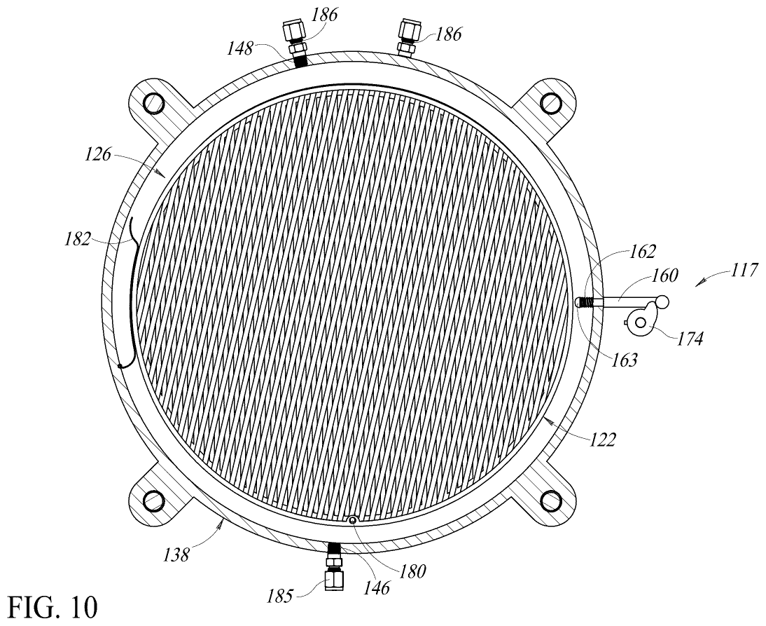

As shown in FIG. 10, rotation of the cam 174 may move (e.g., translate) the strike pin 160 away from the first electrode 122 (or other component that the impactor 117 impacts) and compress the biasing member 162. Further rotation of the cam 174 may release the strike pin 160 such that the biasing member 162, in its compressed configuration, exerts a force on the strike pin 160 moving the strike pin 160 towards the first electrode 122 (or other component that the impactor 117 impacts), as shown in FIG. 9. The impact of the impactor is sufficient to dislodge/liberate some of the bubbles of hydrogen gas 132 and oxygen gas 134 (or other product of the chemical reaction) from the respective first electrode 122 and/or the second electrode 124.

The electrolyzer 120 may include one or more fittings 184 that facilitate entry and exit of liquid and/or gas into and out of the first inner volume 140 and the second inner volume 144. The fittings 184 may include one or more liquid fittings 185 positioned in the first entry passage 146 and/or the second entry passage 150 to facilitate entry of the liquid electrolyte 128 into the electrolyzer 120. The fittings 184 may include one or more gas fittings 186 positioned in the first exit passage 148 and/or the second exit passage 152 to facilitate exit of the gas (e.g., the hydrogen gas 132 and/or the oxygen gas 134) out of the electrolyzer 120.

Referring to FIGS. 2 to 10, a method of electrolysis may include at least partially submerging the first electrode 122 and the second electrode 124 in a liquid electrolyte 128. The method may positively charging the first electrode 122 and negatively charging the second electrode 124 (e.g., by connecting the electrolyzer 120 to the power supply 129). The method may include moving the charged ions within the liquid electrolyte 128 through the diaphragm 126 that is positioned between the first electrode 122 and the second electrode 124.

The method may include forming gas bubbles (e.g., the oxygen gas bubbles 134) on the first electrode 122 (or anode) and forming gas bubbles (e.g., the hydrogen gas bubbles 132) on the second electrode 124 (or cathode). The method may further include impacting the first electrode 122, the second electrode 124, the diaphragm 126, the first portion 138 of the housing 136, the second portion 142 of the housing 136 or any combination thereof, with one or more of the impactor(s) 117, thereby disengaging the gas bubbles from the respective electrode (e.g., the oxygen gas bubbles 134 from the first electrode 122 and the hydrogen gas bubbles 132 from the second electrode 124). The method may include repeating the impacting at regular or irregular intervals.

The method may further include collecting a first gas (e.g., oxygen) from the bubbles as the gas exits the first inner volume 140 (e.g., via one of the fittings 184), collecting a second gas (e.g., hydrogen) from the bubbles as the gas exits the second inner volume 144 (e.g., via one of the fittings 184), or collecting both the first gas and the second gas via respective ones of the fittings 184.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The various embodiments described above can be combined to provide further embodiments.

Many of the methods described herein can be performed with variations. For example, many of the methods may include additional acts, omit some acts, and/or perform acts in a different order than as illustrated or described.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An electrolyzer comprising:
a first electrode at least partially submerged in a liquid electrolyte;
a second electrode, wherein a difference in an electric charge of the first electrode and the second electrode is sufficient to cause a chemical reaction within the liquid electrolyte that results in production of gas bubbles;
a diaphragm positioned between the first electrode and the second electrode;
a housing that at least partially encloses the first electrode, the second electrode, the diaphragm, the liquid electrolyte, or any combination thereof;
an impactor that repeatedly impacts the first electrode, the second electrode, the diaphragm, or the housing with a force sufficient to: dislodge at least some of the gas bubbles that are attached to the first electrode; dislodge at least some of the gas bubbles that are attached to the second electrode; or dislodge at least some of the gas bubbles that are attached to the first electrode and dislodge at least some of the gas bubbles that are attached to the second electrode.

2. The electrolyzer of claim 1 wherein the impactor repeatedly impacts the first electrode, the second electrode, the diaphragm, or the housing at an impact location that is submerged in the liquid electrolyte.

3. The electrolyzer of claim 2 wherein the impactor includes an impact pin that translates in a first direction away from the impact location and also translates in a second direction towards the impact location, and the impactor further includes an actuator that exerts an actuator force against the impact pin, the actuator force moving the impact pin along at least one of the first direction and the second direction.

4. The electrolyzer of claim 3 wherein the impactor includes a biasing member that exerts a biasing force against the impact pin, the biasing force moving the impact pin in the second direction.

5. The electrolyzer of claim 4 wherein the actuator force moves the impact pin in the first direction, thereby compressing the biasing member and generating the biasing force.

6. The electrolyzer of claim 3 wherein the actuator includes a rotatable cam.

7. The electrolyzer of claim 3 wherein the impactor repeatedly impacts the first electrode or the second electrode, the electrolyzer further comprising:
a support at least partially enclosed within the housing and abutting the first electrode or the second electrode at a support location that is opposite the impact location with respect to the second direction.

8. The electrolyzer of claim 7 wherein:
the first electrode is pivotal relative to the housing about a first pivot point, the first pivot point submerged within the liquid electrolyte;
the second electrode is pivotal relative to the housing about a second pivot point, the second pivot point submerged within the liquid electrolyte; or
the first electrode is pivotal relative to the housing about the first pivot point and the second electrode is pivotal relative to the housing about the second pivot point.

9. The electrolyzer of claim 1 wherein the impactor repeatedly impacts the first electrode, the second electrode, the diaphragm, or the housing at regular intervals.

10. The electrolyzer of claim 1 wherein the impactor is a first impactor, the electrolyzer further comprising:
a second impactor that repeatedly impacts the first electrode, the second electrode, the diaphragm, or the housing.

11. The electrolyzer of claim 1 wherein the first electrode and the second electrode are coupled to a power supply, the second electrode is more negatively charged than the first electrode, and production of gas bubbles includes the production of hydrogen gas bubbles that are formed on or adjacent to the second electrode.

12. The electrolyzer of claim 1 wherein the second electrode is at least partially submerged in the liquid electrolyte.

13. A method of electrolysis, the method comprising:
at least partially submerging a first electrode and a second electrode in a liquid electrolyte;
inducing a flow of electrons from the first electrode to the second electrode;
inducing a chemical reaction in the liquid electrolyte, the chemical reaction generating bubbles of a first gas formed closer to the first electrode and further generating bubbles of a second gas formed closer to the second electrode;
impacting the first electrode, the second electrode, or both the first electrode and the second electrode with a force sufficient to: dislodge at least some of the bubbles of the first gas that are attached to the first electrode; dislodge at least some of the bubbles of the second gas that are attached to the second electrode; or dislodge at least some of the bubbles of the first gas that are attached to the first electrode and dislodge the bubbles of the second gas that are attached to the second electrode.

14. The method of claim 13 wherein impacting the first electrode, the second electrode, or both includes repeatedly impacting the first electrode, the second electrode, or both at one or more impact locations that are submerged in the liquid electrolyte.

15. The method of claim 13 wherein repeatedly impacting the first electrode, the second electrode, or both includes translating an impact pin in a first direction away from a respective one of the one or more impact locations and translating the impact pin in a second direction towards the respective one of the one or more impact locations.

16. The method of claim 15 wherein translating the impact pin in the first direction includes exerting an actuator force against the impact pin with an actuator.

17. The method of claim 16 wherein translating the impact pin in the second direction includes exerting a biasing force against the impact pin with a biasing member that is submerged in the liquid electrolyte.

18. The method of claim 17 wherein exerting the actuator force against the impact pin with the actuator compresses the biasing member and generates the biasing force.

19. The method of claim 16 wherein translating the impact pin in the first direction includes abutting the impact pin with a rotatable cam.

20. The method of claim 13, further comprising:
collecting the first gas, the second gas, or both the first gas and the second gas that is released from the dislodged bubbles as the dislodged bubbles exit the liquid electrolyte.
